(19) United States
(12) Patent Application Publication
(10) Pub. No.: US 2003/0028443 A1
(43) Pub. Date: Feb. 6, 2003

(54) Online transactions ledger

(75) Inventors: Trevor Ellis, Grimsby (GB); James Davy, Cleethorpes (GB); Carol McCafferty, Gunness (GB); Jeffrey Wharfe, Bonby (GB)

Correspondence Address: Richard M. Goldberg, 25 East Salem Street, Suite 419, Hackensack, NJ, 07601, US

(73) Assignee: SupplyNetOne Limited

(21) Appl. No.: 10/093,357

(22) Filed: Mar. 7, 2002

(30) Foreign Application Priority Data
Mar. 8, 2001 (GB) 0105694.4

(51) Int. Cl. G06F 17/60; G06G 1/14

(52) U.S. Cl. 705/26; 705/28; 705/22

(57) ABSTRACT

A method and apparatus are provided for communicating between supplier and customers, having a plurality of network-connected terminals, including supplier terminals and customer terminals and at least one co-ordinator terminal equipped with memory means, and said memory means includes instructions to define a transaction space within said network, wherein a customer expresses interest for a particular product to the co-ordinator. Said co-ordinator performs a search to identify the preferred supplier then returns details of said preferred supplier to said customer. Said customer conveys a purchase requirement to the co-ordinator, which then sends a formal order to the supplier. Said supplier conveys payment details to said co-ordinator and said co-ordinator sends a formal invoice to said customer.

### BACKGROUND OF THE INVENTION

1. Field of the Invention

The present invention relates to a method of communicating between suppliers and customers within a transaction space defined within a network.

2. Description of the Related Art

Computer-based supply management systems have been developed in order to facilitate the purchasing function of business organisations. The ever-increasing accessibility to the Internet has further enabled business organisations to supplement said supply management systems with powerful Internet search engines in order to source potential suppliers. In a typical situation, a purchasing officer carries out an Internet search by means of Internet search engines such as Alta Vista or Lycos in order to obtain information about potential suppliers of a particular service or product. Upon finding said information, most often the purchasing officer must contact the potential supplier by a variety of means such as phone, facsimile or e-mail in order to ascertain that the range of services and/or products effectively relate to the organisation's particular requirements. Said potential supplier is eventually approved as a regular supplier and the purchasing officer must then input all details pertaining to the newly-appointed supplier and its products in the database used by the supply management system.

Whereas this time-consuming exercise may be viably employed by small to medium sized business. In large business environments however, ie involving blue chip companies with hundreds of supply channels potentially generating thousands of purchase orders every week, the cost of implementing and maintaining a database large enough to accommodate the requirements of the purchasing function ceases to be negligible as does the cost associated with the time and effort spent by purchase officers to identify and contact potential suppliers and eventually, input their details in said large database.

In addition to the problem of running costs increasing in proportion with the extent of the purchasing function within large business organisations, supply management systems according to the present state of the art do not allow purchase officers to place orders on potential suppliers until the details and products of said potential suppliers have been inputted in said large database and thus tend to generate inertia within the purchasing process. Finally, given the cost of implementing and maintaining supply management systems according to the present state of the art in large business to business environments, which is non-trivial, such systems create a situation of legacy which renders systems and/or software migration towards alternative and potentially better solutions more and more problematic and more and more expensive as they are being used over time.

### BRIEF SUMMARY OF THE INVENTION

According to a first aspect of the present invention, there is provided an apparatus for communicating between suppliers and customers, having a plurality of network connected terminals, including supplier terminals, customer terminal and at least one co-ordinator terminal equipped with memory means, said memory means including instructions to define a transaction space within said network, wherein a customer expresses interest for a particular product to the co-ordinator; said co-ordinator performs a search to identify the preferred supplier; said co-ordinator returns details of said preferred supplier to said customer; said customer conveys a purchase requirement to the co-ordinator; said co-ordinator sends a formal order to the supplier; said supplier conveys payment details to said co-ordinator; and said co-ordinator sends a formal invoice to said customer.

According to a second aspect of the present invention, there is provided a method for communicating between suppliers and customers via supplier terminals, customer terminals and at least one co-ordinator terminal connected to a network. Said co-ordinator terminal defines a transaction space within said network wherein it performs the steps of performing a search to identify the preferred supplier after a customer expressed interest for a particular product, returning details of said preferred supplier to said customer, sending a formal order to said supplier after said customer conveyed a purchase requirement to said co-ordinator, and sending a formal invoice to said customer after said supplier conveyed payment details to said co-ordinator.

### BRIEF DESCRIPTION OF THE SEVERAL VIEWS OF THE DRAWINGS

FIG. 1 illustrates a network environment, including customer terminals, supply terminals and a co-ordinator terminal sharing data over a network environment;

FIG. 2 illustrates hardware components of a terminal of the type illustrated in FIG. 1, including a memory;

FIG. 3 details the contents of the memory of the co-ordinator terminal shown in FIG. 1, including a transaction application and a plurality of databases;

FIG. 4 details the contents of the memory of the supplier terminal shown in FIG. 1, including a products database;

FIG. 5 details the contents of the memory of the customer terminal shown in FIG. 1:

FIG. 6 illustrates the flow of data between the supply terminals, the customer terminals and the co-ordinator terminal over the network;

FIG. 7 summarises actions performed at the co-ordinator terminal in order to define a transaction space and co-ordinate the communication between supplier terminals and customer terminals;

FIG. 8 summarises actions performed at the co-ordinator terminal in order to update the portals shown in FIG. 7;

FIG. 9 illustrates actions performed at the co-ordinator terminal in order to create a customer portal shown in FIG. 8;

FIG. 10 summarises actions performed at the co-ordinator terminal in order to create a supplier database shown in FIG. 8;

FIG. 11 summarise actions performed at the co-ordinator terminal in order to identify one or a plurality of suppliers amongst all the suppliers present within the transaction space;

FIG. 12 summarises the actions performed at a customer terminal in order for the co-ordinator terminal to receive purchase requirements from said customer;

FIG. 13 shows the flow of data between a customer terminal and the co-ordinator terminal according to the actions shown in FIG. 12;

FIG. 14 summarises actions performed at the co-ordinator terminal in order to forward a formal purchase order to the supplier based on the requisition list shown in FIG. 12;

FIG. 15 shows the customer administration database, the supplier administration database and the connections database stored in the co-ordinator terminal, subsequently to the forwarding of a purchase order detailed in FIG. 14;

FIG. 16 summarises actions performed at the co-ordinator terminal to update the various databases shown in FIG. 15;

FIG. 17 summarises actions performed at a supplier terminal in order for the co-ordinator terminal to receive payment details from said supplier;

FIG. 18 summarises actions performed at the co-ordinator terminal in order to forward a formal invoice to the customer based on the payment details shown in FIG. 17,

FIG. 19 shows the customer administration database, the supplier administration database and the connections database stored in the co-ordinator terminal, subsequently to the closure of a transaction detailed in FIG. 18;

### BEST MODE FOR CARRYING OUT THE INVENTION

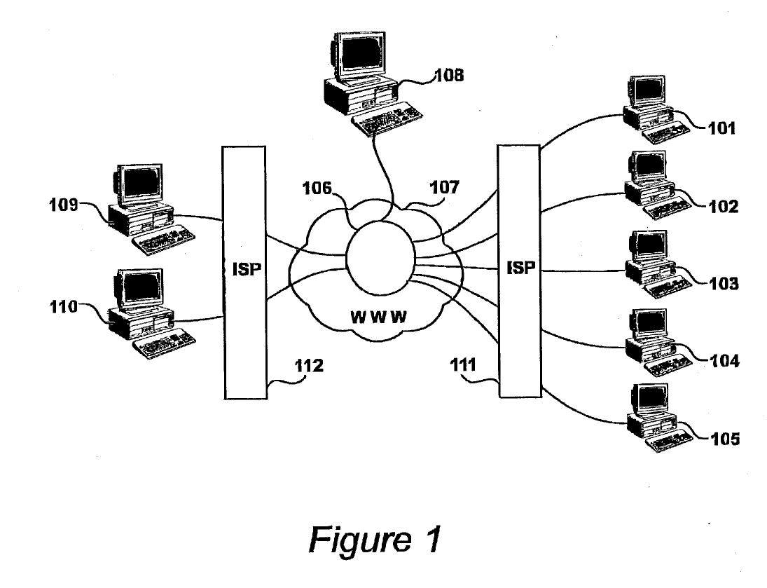

The invention will now be described by way of example, only with reference to the previously identified drawings. An environment for connecting multiple users from whom data will be obtained and to whom data will be distributed is illustrated in FIG. 1.

FIG. 1

Supplier terminals 101, 102, 103, 104 and 105 of suppliers S1, S2, S3, S4 and S5 respectively are connected via Internet service provider (ISP) 111 to a transaction space 106 defined within the Internet 107 by co-ordinator terminal 108. The ISP 111 provides each individual supplier terminal user with a unique IP address, e-mail account and other optional Internet facilities such as are commonly provided to a user with an ISP account. Provided that appropriate data transfer applications, protocols and permissions have been set up, there is provided the scope for any one of supplier terminals 101 to 105 to send data to- and access data from server 108.

Similarly, customer terminals 109 and 110 of customers C1 and C2 respectively are also connected via Internet service provider (ISP) 112 to a transaction space 106 defined within the Internet 107 by co-ordinator terminal 108. The ISP 112 provides each individual customer terminal user with a unique IP address, e-mail account and other optional Internet facilities such as are commonly provided to a user with an ISP account. Provided that appropriate data transfer applications, protocols and permissions have been set up, there is provided the scope for any one of supplier terminals 101 to 105 and for either of customer terminals 109 and 110 to send data to- and access data from server 108.

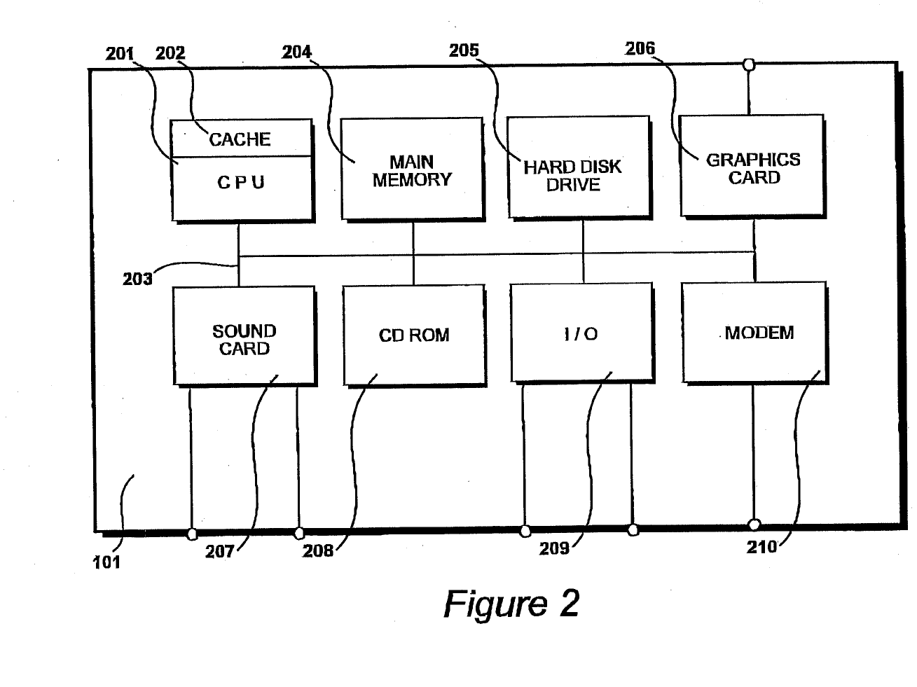

Hardware forming the main part of any of the supplier terminal 101, which is similar in all respects to all of the other supplier terminals 102 to 105, the customer terminals 109 and 110 and co-ordinator terminal 108 shown in FIG. 1, is illustrated in FIG. 2.

FIG. 2

A central processing unit 201 executes instructions and manipulates data. Frequently-accessed instructions and data are stored in a high speed cache memory 202. The central processing unit 201 is connected to a system bus 203. This provides connectivity with a larger main memory 204, which requires significantly more time to access than the cache 202. The main memory 204 contains between 64 and 128 megabytes of dynamic random access memory. A hard disk drive (HDD) 205 provides non volatile bulk storage of instructions and data. A graphics card 206 receives graphic data from the CPU 201, along with graphics instructions. Preferably, the graphics card 206 includes substantial dedicated graphical processing capabilities, so that the CPU 201 is not burdened with computationally intensive tasks for which it is not optimised. Similarly, sound card 207 receives data from the CPU 201, along with sound processing instructions. Preferably, the sound card 207 includes substantial dedicated sound processing capabilities, so that the CPU 201 is not burdened with computationally intensive tasks for which it is not optimised. A CD ROM reader 208 receives process instructions and data from an external CD ROM medium. A serial input/output interface 209 provides connectivity to peripherals such as a mouse and keyboard. A modem 210 provides connectivity to the Internet via a telephone connection to the user's ISP, in the example ISP 111. The equipment shown in FIG. 2 constitutes a personal computer of fairly standard type, such as an IBM PC compatible or Apple Macintosh, whether used as a network terminal or as a network server.

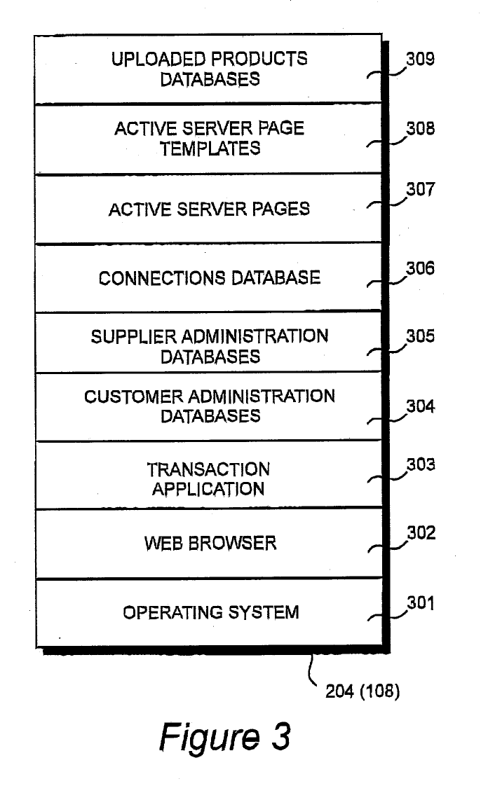

The contents of the memory 204 of the co-ordinator terminal 108 shown in FIGS. 1 and 2 are summarised in FIG. 3.

FIG. 3

An operating system, including a basic bios is shown at 301. This provides common functionality shared between all applications operating on the terminal 108, such as disc drive access, file handling and Window based graphical user interfacing (GUI). A web browser, such as Internet Explorer is shown at 302, which includes instructions to browse the Internet, provide functionality to hypertext links embedded in web pages and generally process instructions written in HyperText Markup Language (HTML), Javascript. Visual Basic script, Active Server Pages and other programming languages known to those skilled in the art. Transaction application 303 comprises the program steps required by the CPU 201 to act upon databases, the type of which comprises customer administration databases 304, supplier administration databases 305 and a connections database 306. Memory 204 also includes active server pages 307 and active server page templates 308. Memory 204 finally includes uploaded product databases 309, the function of which will be detailed further in the present embodiment.

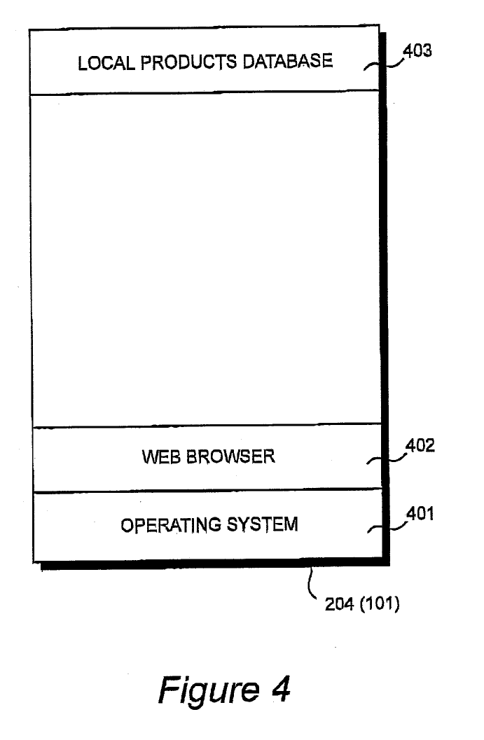

Alternatively, the contents of the memory 204 of the supplier terminal 101 shown in FIGS. 1 and 2 are summarised in FIG. 4.

FIG. 4

Similarly to the memory 204 of co-ordinator terminal 108, memory 204 of supplier terminal 101 also includes an operating system 401 including a basic bios, which provides common functionality shared between all applications operating thereon, such as disc drive access, file handling and window based graphical user interfacing. Web browser 402 is identical in functionality to web browser 302 of co-ordinator terminal 108. Web browser 402 comprises the program steps required by the CPU 201 of supplier terminal 101 to act upon a local products database 403.

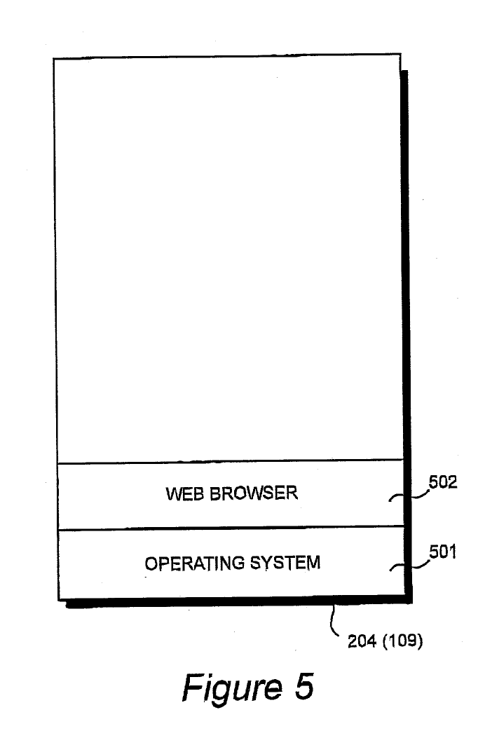

Alternatively, the contents of the memory 204, of customer terminal 109 shown in FIGS. 1 and 2 are summarised in FIG. 5.

FIG. 5

Similarly to the co-ordinator terminal 108 and supplier terminal 101, memory 204 of customer terminal 109 also includes an operating system, including a basic bios, which provides common functionality shared between all applications operating thereon, such as disc drive access, file handling and window based graphical user interfacing. Operating system 501 is preferably, but not necessarily, identical to operating systems 401 and 301. Web browser 502 is identical in functionality to web browser 402 of supplier terminal 101 and web browser 302 of co-ordinator terminal 108.

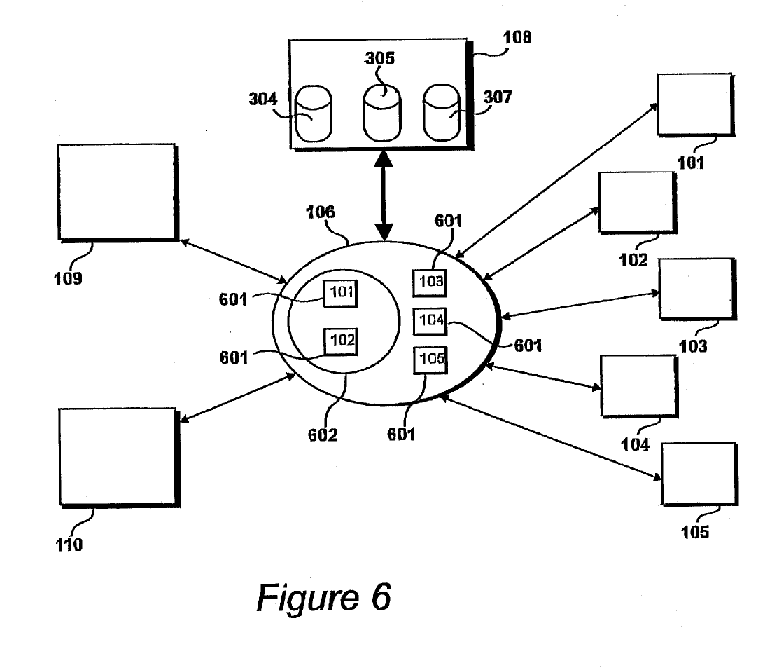

According to the present invention, the need for a purchase officer operating customer terminal 109 or 110 to search for potential suppliers by using a generic search engine, visiting the web sites of the suppliers identified as potentially suitable in order to obtain products and or services information and pricing, contacting said suppliers further in accordance with appointment procedures, then inputting all of the details relating to newly-appointed suppliers, their products and any other relevant information are not required anymore. The search for potential suppliers is carried out by the co-ordinator terminal amongst the supplier databases present within the transaction space. The definition of said transaction space 106 in effect removes hundreds and potentially thousands of redundant search results returned by generic search engines by providing a specific search engine within a confined environment, the transaction space 106, which is accessible to customer terminals through topical or geographical portals. Said transaction space is graphically illustrated in FIG. 6.

FIG. 6

Transaction space 106 is represented as including virtual representations 601 of the suppliers databases 305. Upon being accessed by means of a browser such as browsers 302, 402 and 502, each of said virtual representations, to be known as supplier sites according to the present invention, displays product information stored in products databases 309 which were initially uploaded from the local product databases 403 respectively stored in supplier terminals 101, 102, 103, 104 and 105.

According to the prior art, a purchase officer operating customer terminal 109 would be accessing Internet pages displaying said information which would be stored either in said supplier terminals 101 to 105 or in an Internet server operated by their respective ISPs. Thus, according to the prior art, transaction space 106 may rightly be assimilated as the Internet itself. However, according to the present invention, said supplier sites 601 are in effect active server pages (ASP) stored in co-ordinator terminal 108, which display information having been provided by supplier terminals 101 through to 105. Thus, according to the present invention, the extent of transaction space 106 is directly proportional to the number of suppliers who provide information, by means of their respective supplier terminals, to co-ordinator terminal 108. In this respect, transaction space 106 is therefore to be understood as a portion of the Internet 107 appropriated by co-ordinator terminal 108 and subsequently defined by means of active server pages 307.

As suppliers provide company and product information by means of their respective supplier terminals to supplier administration databases 305 and uploaded product databases 309 of co-ordinator terminal 108, wherein active sever pages are subsequently generated in order to enrich transaction space 106, customers consult said transaction space 106 by means of their respective customer terminals in order to identify potential suppliers who can meet their requirements and from whom they may therefore purchase products or services.

Customers such as customers C1 and C2 thus also provide co-ordinator 108 with information in order for co-ordinator terminal 108 to define a customer portal 602 within transaction space 106. Said portal 602 is a virtual representation of a topical or geographical area of interest within transaction space 106; for instance, customer C1, by means of its respective customer terminal 109, indicates what is its business area and thus its type of requirements, whereas customer C2, by means of its respective customer terminal 110, indicates where is its factory located and thus where to source its requirement geographically. As co-ordinator terminal 108 stores and manages supplier sites 601 and customer portal 602, it is able to provide accurate search results from within transaction space 106 to customers who have specified supplier search criteria, and customer portal 602 provides the means to simplify and thus further accelerate the processing of said search by co-ordinator terminal 108.

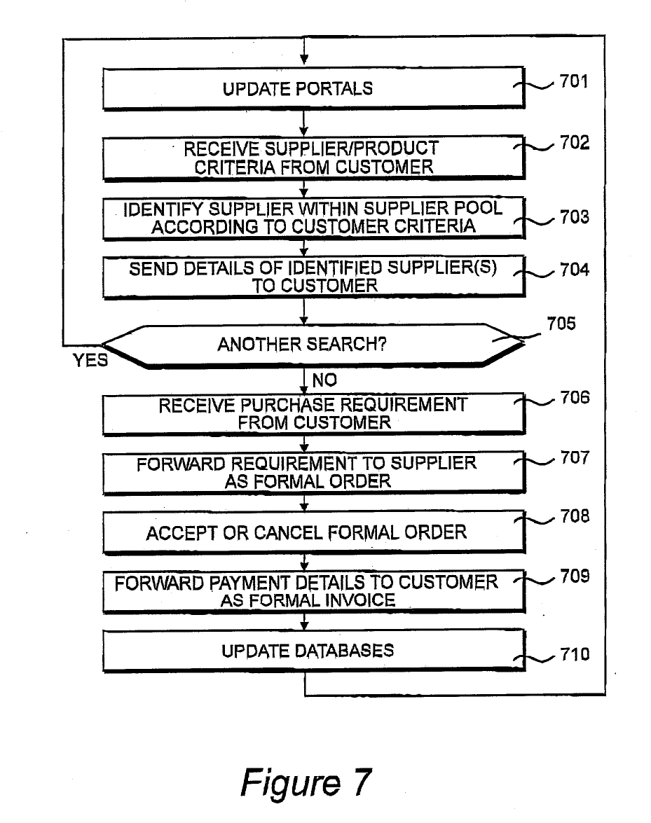

The steps performed by the co-ordinator terminal 108 in order to define and maintain the transaction space, provide customers with pertinent information about potential suppliers, process and co-ordinate orders and invoices between customers and suppliers within the transaction space are detailed in FIG. 7.

FIG. 7

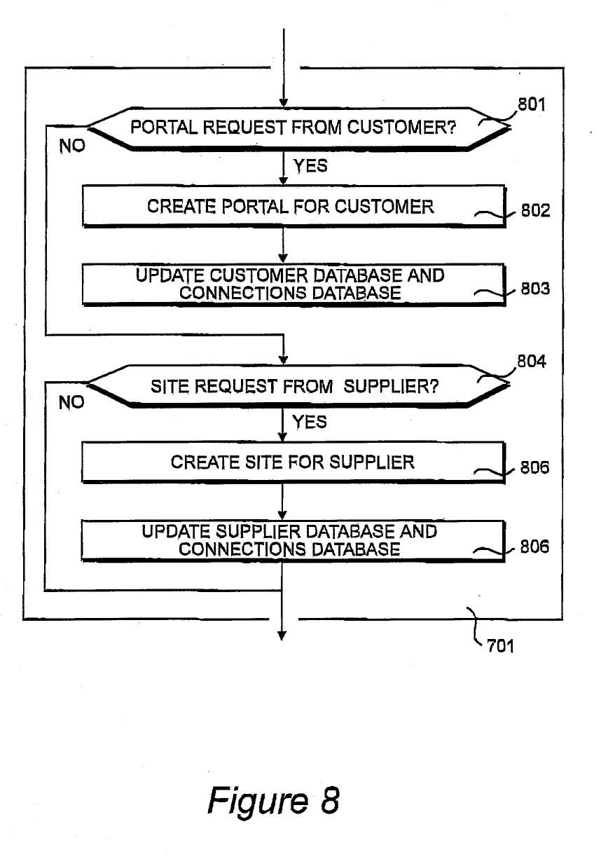

At step 701, the co-ordinator terminal 108 updates the portals and, by carrying out this update, updates the entire transaction space 106. The step of updating portals obviously includes the creation of customer portals 602 or supplier sites 601, upon customers or suppliers joining the transaction space 106 for the first time, The steps performed by the co-ordinator terminal 108 in order to create said portals are detailed in FIG. 8.

FIG. 8

At step 801 a question is asked as to whether the co-ordinator terminal has received a portal creation request. If the question at step 801 is answered positively then, at step 802, transaction application 303 creates a customer portal 602 and subsequently updates the customer administration database 304 and the connections database 306 at step 803.

Alternatively, if the question that was asked at step 801 was answered negatively, then the process moves directly to question 804, which asks whether the co-ordinator terminal has received a site creation request. If the question asked at step 804 is answered positively, then transaction application 303 creates a supplier site 601 at step 805 and updates the supplier administration database 305 and the connections database 306 at step 806. If the question asked at step 804 is answered negatively, the transaction application considers the creation request void and control is directed to step 702, which will be detailed further in the present embodiment.

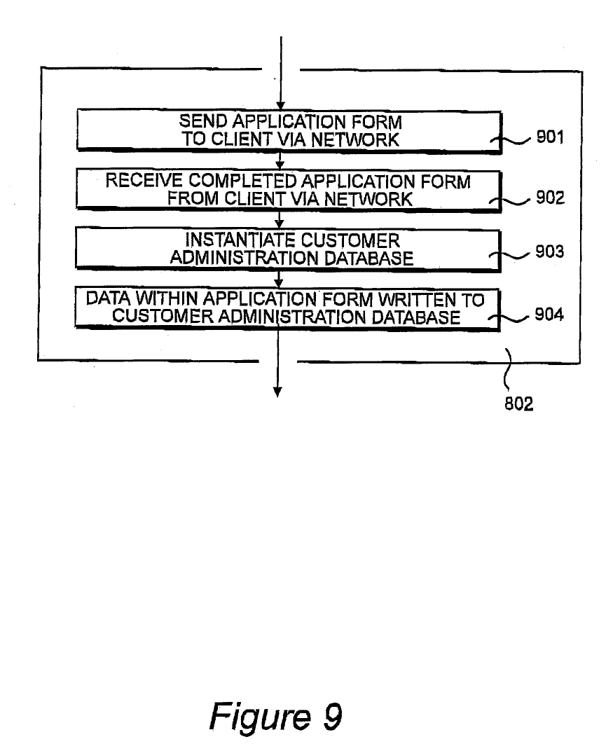

The creation of the customer portal 602 by the co-ordinator terminal at step 802 is further detailed in FIG. 9.

FIG. 9

At step 901 the transaction application 303 sends an application form to the requesting customer over the network. Said application form is an active server page template such as active server page template 308. At step 902, the co-ordinator terminal receives the completed application form from the requesting customer via the network, after the active server page template was completed at the requesting customers terminal. At step 903, application instructions 303 instantiate a customer administration database specific to the requesting customer, and stored as one of a plurality of customer administration databases 304. At step 904, the data which was entered within the application form is written to the specific customer administration database stored in the memory 204 of co-ordinator terminal 108.

Portions of the data that was written in the application form at the customers terminal 109 define topical or geographical areas of potential interests for the operator of said customer terminal and thus assists in further delimitating the area of interest of the operator of customer terminal 109 within the transaction space 106, which is thus assimilated as a portal 602.

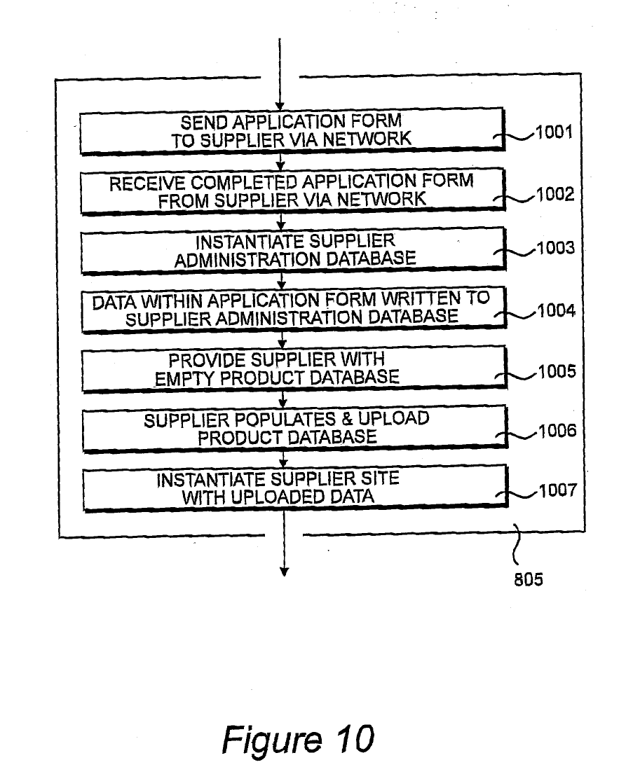

The creation of a supplier site 601 at step 806 by transaction application 303 of co-ordinator terminal 108 is further detailed in FIG. 10.

FIG. 10

At step 1001, the transaction application 303 sends an application form to the requesting supplier via the network. As in the case of the customer portal creation shown in FIG. 9, said application form is an active server page template such as active server page template 308 stored in memory 204 of co-ordinator terminal 108. Upon said requesting supplier appropriately inputting data within the application form sent at step 1001, the co-ordinator terminal receives the completed application form via the network at step 1002. At step 1003, application instructions 303 in main memory 204 of co-ordinator terminal 108 instantiate a supplier administration database specific to the requesting supplier, and stored as one of a plurality of supplier administration databases 305. The data contained within said application form is subsequently written to the said supplier administration database 305 in main memory 204 of co-ordinator terminal 108 at step 1004.

Before the requesting supplier's site can be published within transaction space 106, however, the transaction application 303 provides supplier terminal 101 with an empty product database 403 at step 1005. The operator of supplier terminal 101 at supplier S1 must subsequently populate product database 403 With details of the products and/or services traded by its organisation by means of browser 402 and the terminal's input means, such as a keyboard and/or a mouse. Once completed, said local product database is uploaded to co-ordinator terminal 108 at step 1006, wherein it is stored as part of uploaded products database 309. At step 1007, transaction application 303 subsequently instantiates a supplier site 601 within transaction space 106, which consists of Active Server Pages 307 specific to supplier S1, with said ASP 307 structured from ASP templates 308 and containing product or services data specific to supplier S1 which is stored in uploaded products database 309.

Thus, there is provided an apparatus for communicating between customers and suppliers, wherein customers have defined an area of preferred interest, referred to as a portal 602, within a closed on-line environment, referred to as the transaction space 106, within which there exists one or a plurality of standard suppliers' sites 601 including product and/or services and supplier information, the format and presentation 307 of which is virtually identical regardless of the product and/or services on offer, as they are generated according to a unique and common set of active server page templates 308.

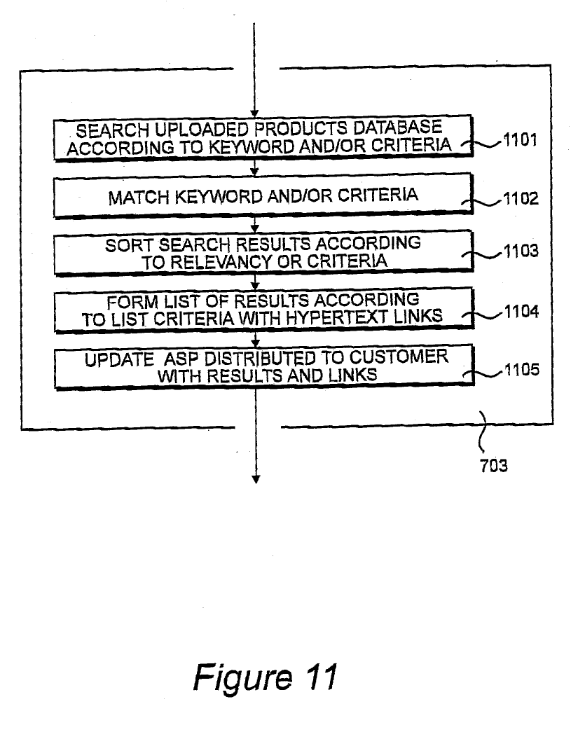

Referring back to FIG. 7, after updating the portals at step 701, details of which are shown in FIGS. 8, 9 and 10, the co-ordinator terminal receives search criteria specified by operators of customer terminals, such as customer terminal 109, at step 702. Suppliers and/or their products or services are subsequently identified amongst the pool of supplier sites 601 within transaction space 106 at step 703 according to the search criteria received at step 702. Details of the steps performed in order to achieve the identification performed at step 703 are shown in FIG. 11.

FIG. 11

At step 1101, transaction application 303 searches the uploaded product databases 309 according to the keyword(s) and or criteria specified by the operator of customer terminal 109 through web browser 502. Said keyword(s) and/or criteria are subsequently matched against entries contained within the uploaded product databases 309 at step 1102. The search results retrieved by transaction application 303 are preferably sorted according to the relevancy or criteria specified as part of the overall search issued from customer terminal 109 at step 1103. Once sorted, said search results are formatted as a list which Includes links to the active server pages said results are stored in. Said links are preferably formatted as hypertext links.

At step 1105, the active server pages 307 distributed to the web browser 502 of customer terminal 109 are updated with the list of results as hypertext links, such that details of the suppliers or products identified according to the search are sent to the requesting customer at step 704.

Referring back to FIG. 7, at step 705 a question is asked as to whether another search is required. This step is required if the results returned by the co-ordinator terminal 108 to the requesting customer terminal 109 do not satisfy the search criteria specified by the operator of said requesting customer terminal 109 or if the search itself requires further refinement based upon the initial results returned. Thus, should another search be required, control is directed back to step 701, wherein the transaction application 303 can subsequently update the portals 602 and potentially further enrich the pool of supplier sites 601 present within transaction space 106, such that search criteria previously unmatched or matched with unsatisfactory results and which prompted question 705 to be answered positively may be eventually be matched with satisfactory results such that question 705 is answered negatively.

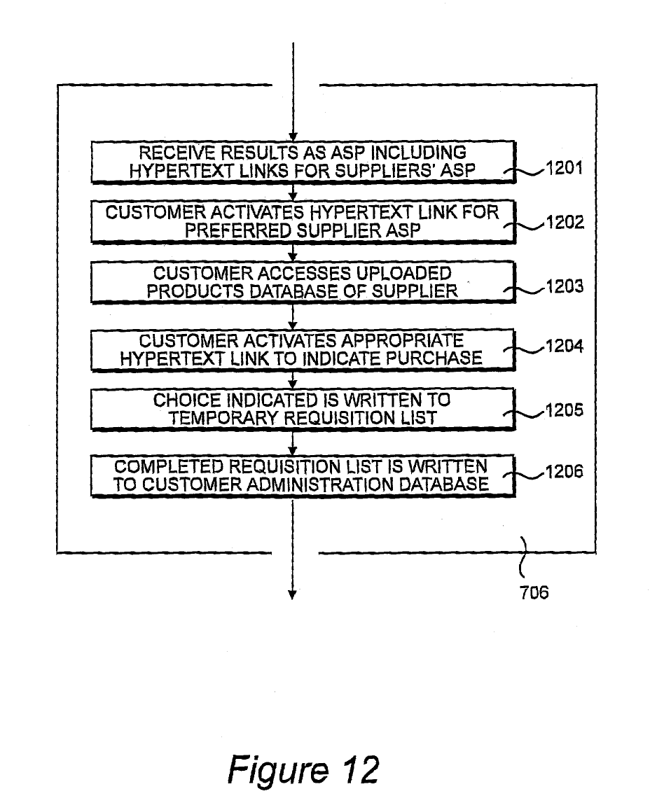

Upon the question asked at step 705 being answered negatively, the co-ordinator terminal eventually receives a requisition list from a customer terminal, such as customer terminal 109, at step 706. Actions performed at customer terminal 109 in order for co-ordinator terminal to receive said requisition list at step 706 are further detailed in FIG. 12.

FIG. 12

Upon receiving an active server page which includes the suppliers and/or products identified from search criteria and their respective hypertext links at step 1201, ie after co-ordinator terminal 108 carried out step 704, the operator of customer terminal 109 activates the hypertext link which will direct his web browser 502 to the active server page 307, ie site of the preferred supplier within the list of supplier sites found within transaction space 106 at step 1202. The browser 502 of customer terminal 109 subsequently accesses the ASP 307 containing data stored in the uploaded product database 309 of said preferred supplier at step 1203. Eventually the operator of customer terminal 109 activates the appropriate ‘product’ hypertext link within ASP 307 to indicate a purchase decision at step 1204. Such a hypertext link typically takes the form of a button displayed within the graphical user interface of web browser 502. Upon activating said appropriate hypertext link, the choice of product or services associated with said hypertext link is written to a temporary requisition list stored as part of the preferred suppliers administration database 304 stored in co-ordinator terminal 108 at step 1205. Steps 1204 and 1205 can be repeated until the requisition list is deemed complete and is thus written to the preferred supplier's administration database 304 at step 1206.

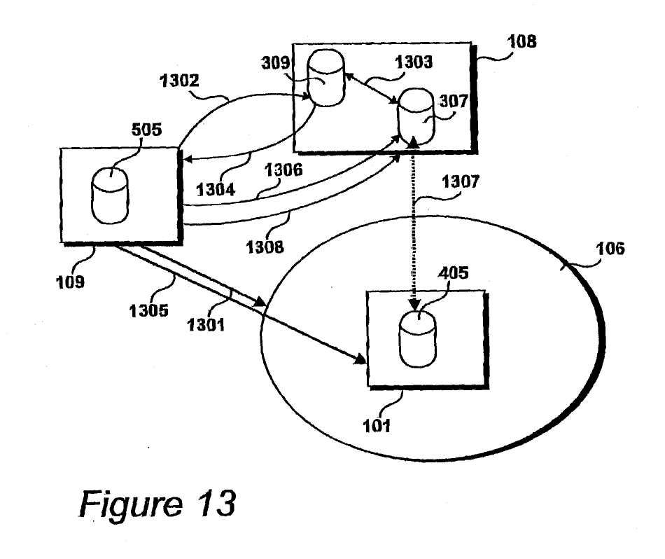

A graphical representation of the data flow generated by the actions shown in FIGS. 11 and 12 is shown in FIG. 13.

FIG. 13

According to the invention, the purchase officer operating customer terminal 109 initially carries out a supplier and/or product search 1301 either within the organisation's portal within transaction space 106 or within the entire transaction space 106 itself. Said search 1301 is for instance motivated by specific purchase requirements or is part of a cost-comparison exercise. In effect, browser 502 of customer terminal 109 forwards a search criteria to transaction application 303 of co-ordinator terminal 108. Said transaction application 303 searches uploaded product databases 309 in order to match the search criteria 1302. Uploaded product databases 309 and ASP 307 are linked (1303) as said ASP 307 contain information relating to the supplier products stored in said uploaded product databases 309. Transaction application 303 subsequently forwards the results 1304 to customer terminal 109, according to steps 703 and 704.

Upon activating hypertext links to access the preferred supplier amongst the returned results 1304, in the example supplier S1, the purchase officer operating customer terminal 109 accesses (1305) the uploaded products database 309 of supplier S1 in order to select the appropriate products or services corresponding to the particular purchase requirements. In effect, upon activating the hypertext link within the graphical user interface of web browser 502, browser 502 accesses (1306) the ASP 307 which store the detail of the products or services of supplier S1 within the co-ordinator terminal 108. Said ASP 307 store all of the details pertaining to the products or services of supplier S1 which were inputted in local products database 403 and, owing to their ‘active’ dynamic characteristic, are automatically updated (1307) with any changes locally implemented in said products database 403 at supplier terminal 101.

Thus, whereas according to the prior art any updates to uploaded product databases 309 and/or ASP 307 would have to be carried out locally by the purchase officer operating customer terminal 109, upon said purchasing officer receiving notification of said updates from supplier S1 by means of telephone, facsimile or e-mail, as said supplier database is stored in the customers terminal according to the prior art, the present invention enables said purchase officer to search for appropriate products or services within a supplier database which is permanently updated by the suppliers themselves.

Furthermore, as the active server pages representing the offer of each and every supplier product database 309 are invariably based upon ASP templates 308, the purchase officer operating customer terminal 109 is able to browse the products or services and pricing thereof of multiple suppliers, either appointed or potential, within a common format which, therefore, further facilitates a direct comparison between suppliers and their offers. Finally, the length of time required for the purchase officer operating customer terminal 109 to search, identify and consult suppliers and their offer is shortened, as the co-ordinator terminal returns results based upon the contents of uploaded product databases 309 and, as such, eliminates the redundant search results traditionally returned in their hundreds or even thousands by generic internet search engines, which utilise Boolean search parameters.

Accordingly, the generation of an appropriate temporary requisition list at customer terminal 109 is also simplified, again owing to the standard format of the active server pages, and is subsequently sent (1308) to co-ordinator terminal 108, which receives said completed temporary requisition list at step 706.

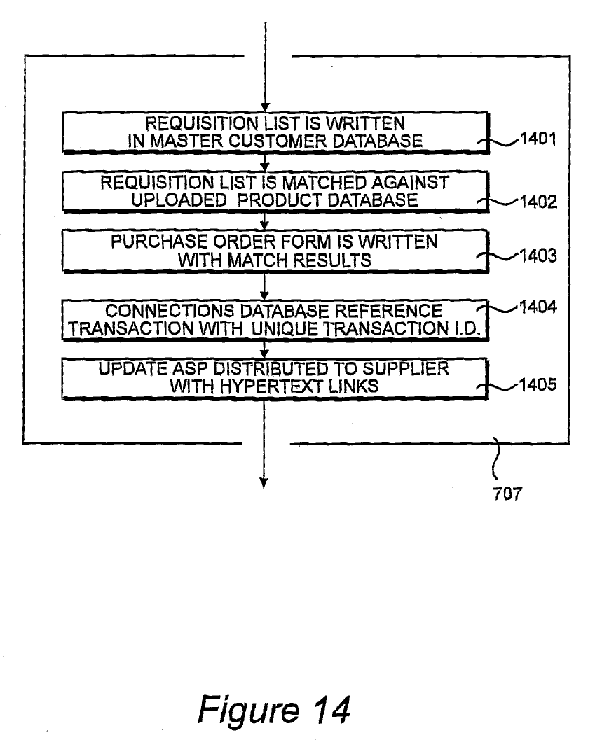

In order for co-ordinator terminal 108 to forward the temporary requisition lists issued by customer terminal 109 to supplier terminal 101 as a formal order at step 707, a number of steps are performed by transaction application 303, which are further detailed in FIG. 14.

FIG. 14

At step 1401, the requisition list received from customer terminal 109 is written to the customer administration database 304 of customer C1. As said requisition list consists of a list of products or services indexed within active server pages 307 from uploaded products database 309 and selected by the purchase officer operating customer terminal 109 by means of their respective hypertext links, the contents of said requisition list are matched against their respective references within the suppliers uploaded product database 309 at step 1402. Transaction application 303 subsequently writes a standard purchase order form within customer administration database 304 with the match results at step 1403, which replaces the original temporary requisition list.

Upon achieving the completion of the standard purchase order at step 1403, a transaction is therefore initiated and transaction application 303 references said transaction with a unique transaction ID generated by connections database 306 at step 1404. The unique transaction ID generated at step 1404 ensures that the requisition list generated at customer terminal 109 is uniquely associated with the purchase order generated by co-ordinator terminal 108 and that said purchase order is accurately matched with payment details which will be received from supplier terminal 101 when the products or services specified within the purchase order have been delivered. Thus, at step 1405, transaction application 303 updates the ASP 307 distributed to supplier S1 such that the purchase order generated from the requisition list of customer S1 is subsequently distributed to the supplier S1.

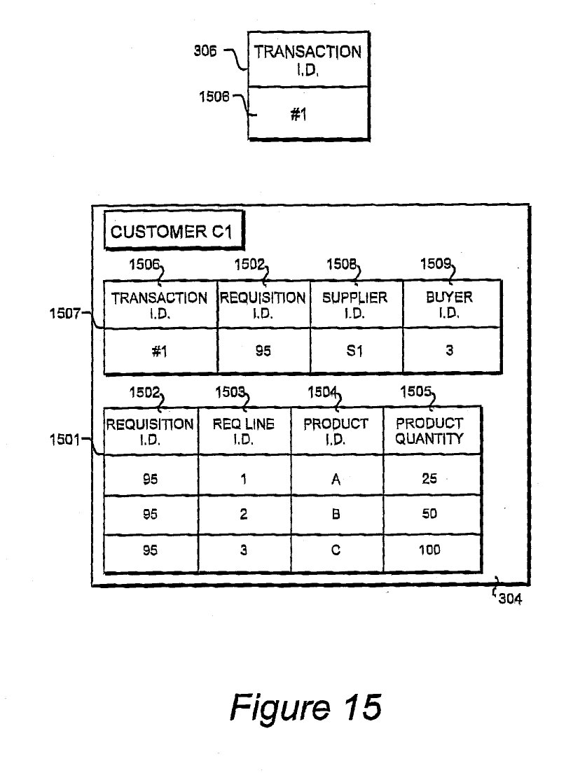

The customer database 304 stored in co-ordinator terminal 108 and updated according to steps 1401 to 1405 is shown in FIG. 15.

FIG. 15

Customer administration database 304 of customer C1 is shown and stores a requisition list table 1501 which includes a temporary requisition list identifier 1502, requisition list line identifiers 1503, supplier product line references 1504 and required quantities 1505.

Upon co-ordinator terminal 108 writing the temporary requisition list data 1502 to 1505 generated at customer terminal 109 within table 1501 as per step 706, the customer administration database 304 is updated accordingly and, upon transaction application 303 completing the writing of the corresponding standard purchase order form as per step 1403, connections database 306 instantiates a new transaction ID 1506. Transaction application 303 subsequently references requisition list data 1502 to 1505 in a second table 1507 by means of the transaction ID 1506, requisition list identifier 1502, the supplier ID 1508 within supplier administration database 305 to whom the purchase order will be distributed and the buyer ID 1509 inputted in the customer administration database 304 at the time of creating the customer portal 602.

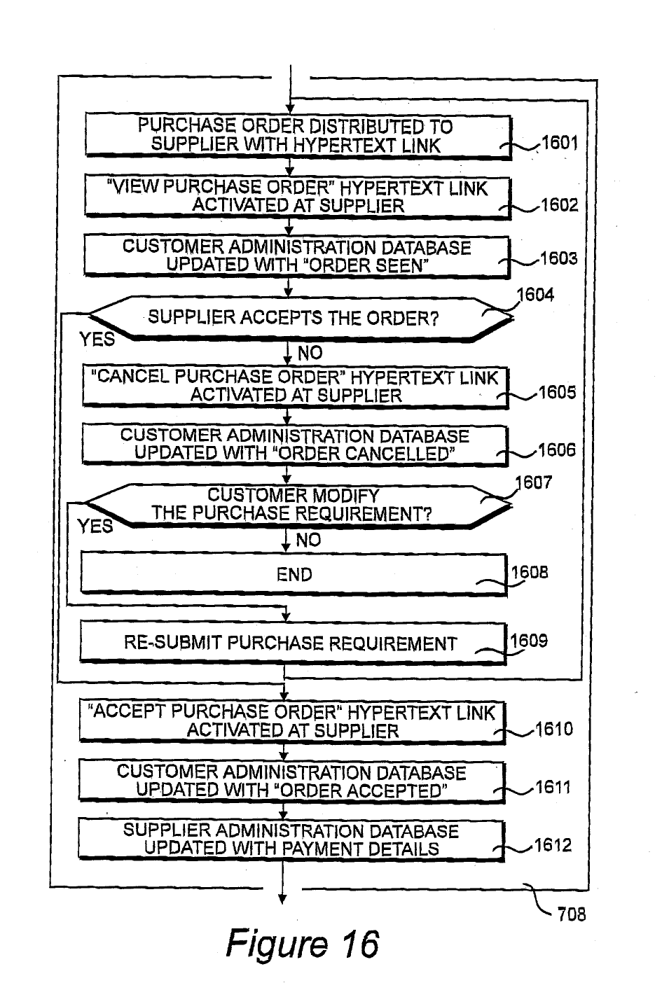

Transaction application 303 eventually forwards, the purchase order referenced 1502 to supplier S1 according to step 1405, at which point supplier S1 can either accept or reject said purchase order according to step 708. The steps performed at co-ordinator terminal 108 to update the supplier administration database 305 of supplier S1 and the customer administration database 304 of supplier C1 in response to supplier input at said step 708 are further detailed in FIG. 16.

FIG. 16

As the ASP 307 pertaining to the corresponding purchase order are distributed to supplier terminal 101 at step 1405, the browser 402 displayed at supplier terminal 101 is updated with the corresponding purchase order, including a plurality of hypertext links, at step 1601. At step 1602, the sales officer operating said supplier terminal 101 activates a first hypertext link “view purchase order” in order to see the details of the requirements forwarded by customer C1. As said first hypertext link is activated, the customer administration database 304 is updated accordingly at co-ordinator terminal 108 with a “purchase order seen” status at step 1603, such that the purchase officer operating customer terminal 109 is now able to confirm that supplier S1 has received and seen the purchase requirement.

A question is then asked at step 1604 wherein the sales officer at supplier S1 can either accept the order or cancel it, for instance if customer C1 has outstanding payments or if products or services specified in said order are not available for supply. If the sales officer chooses to cancel the order, then at step 1605 a second hypertext link “cancel purchase order” is activated. The customer administration database 304 is updated accordingly at co-ordinator terminal 108 with a “order cancelled” status at step 1606, such that the purchase officer operating customer terminal 109 is now able to confirm that supplier S1 has declined the purchase requirement.

Said purchase officer may now either modify the purchase order or abandon the purchase requirement according to a question asked at step 1607. If the purchase requirement is abandoned, then the ordering process is terminated at step 1608 and customer database 304, connections database 306 and the ASP 307 distributed to supplier terminal 101 are purged of all the details pertaining to the purchase order cancelled, wherein control is directed to step 710. Alternatively, the purchase requirement is re-submitted at step 1609, after the purchase officer modified the purchase requirement in regard of the order's initial cancellation.

If the sales officer chooses to accept the order, however, then at step 1610 another second hypertext link “accept purchase order” is activated. The customer administration databass 304 is updated accordingly at co-ordinator terminal 108 with a “order accepted” status at step 1611, such that the purchase officer operating customer terminal 109 is now able to confirm that supplier S1 has accepted the purchase requirement. At step 1612, the supplier administration database 305 is updated with the details of the purchase order such that payment details may be retrieved against the products or service ordered in order to eventually generate a corresponding invoice.

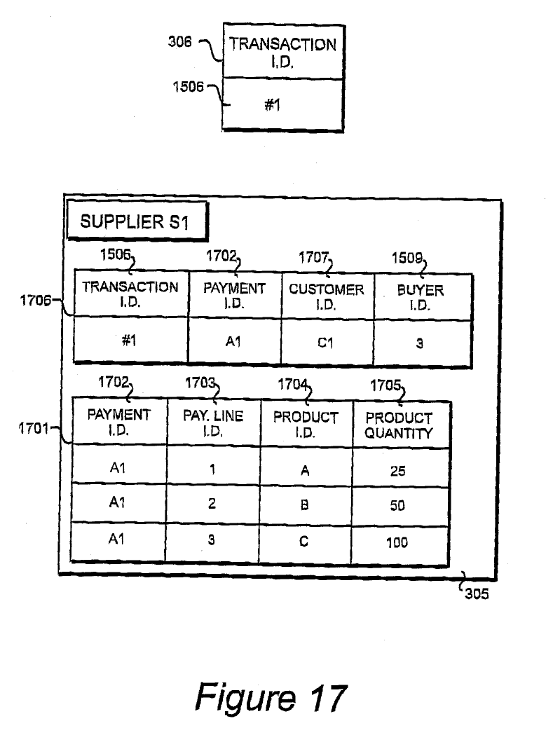

The supplier database 305 stored in co-ordinator terminal 108 and updated according to step 1612 is shown in FIG. 17.

FIG. 17

Supplier administration database 305 of supplier S1 is shown and stores a payment details 1701 which includes a payment list identifier 1702, payment list line identifiers 1703, product line references 1704 and required quantities 1705.

Upon co-ordinator terminal 108 writing the payment list data 1702 to 1705 generated at supplier terminal 101 within table 1701, which is based upon the purchase order received at step 1601 according to the invention, the transaction ID 1506 instantiated in connections database 306 and uniquely referencing said purchase order received at step 1601 is duplicated in supplier administration database 305 such that transaction application 303 references said payment list data 1702 to 1705 in a second table 1706 by means of the transaction ID 1506, payment details identifier 1702, the customer ID 1707 within customer administration database 304 to whom the invoice will be distributed and the buyer ID 1509 inputted in the customer administration database 304 at the time of forwarding the requisition list.

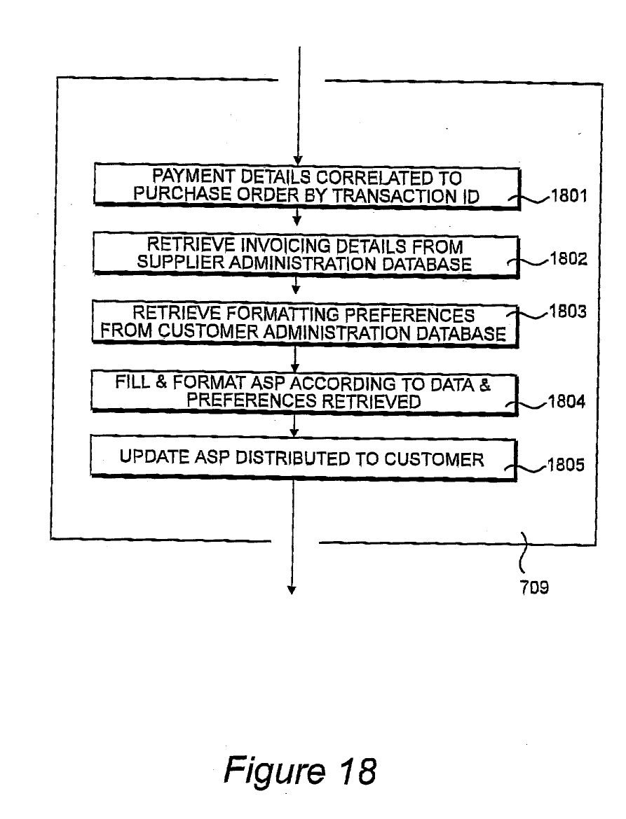

Transaction application 303 eventually forwards the invoice referenced 1702 to supplier S1. Referring back to FIG. 7, upon accepting the purchase order received from co-ordinator terminal 108, payment details are obtained from the supplier administration database 304 of supplier S1 relating to said supply and sent to customer C1 at step 709. The steps performed at co-ordinator terminal 108 to retrieve payment details and distribute an invoice at said step 709 are further detailed in FIG. 18.

FIG. 18

As the supplier database 305 is updated with an “order booked in” status according to step 1612, the ASP 307 pertaining to the corresponding purchase order distributed to supplier terminal 101 are accordingly updated, whereby transaction application 303 matches the purchase order 1507 stored in customer administration database 304 with the transaction ID 1506, and the corresponding invoice 1706 stored in supplier administration database 305 with the transaction ID 1506, by means of transaction ID 1506 in connections database 306 at step 1801.

At step 1802, transaction application 303 retrieves the invoice data 1701 and the supplier invoicing preferences which were received at step 701 when the supplier site was created, from supplier administration database 305. Said preferences include for instance a preferred method of payment, a specific period of credit for payment and the like. In a manner similar to the writing of the formal purchase order of step 1403, transaction application 303 generates a formal standard invoice from the details obtained according to the matching operation performed at step 1801 and the data retrieved.

At step 1803, transaction application 303 retrieves the customer preferences which were received at step 701 when the customer's portal was created, from customer administration database 304. Said preferences include for instance a preferred method of invoice communication such as receiving invoices as an active server page 307, an e-mail, a facsimile or a standard letter. In a manner similar to the writing of the formal purchase order of step 1403, transaction application 303 generates the finished invoice from the standard invoice generated at step 1802 and the preferences retrieved.

According to a preferred embodiment of the present invention, the invoice is distributed as an active server page which is therefore updated with the finished invoice details at step 1805, such that customer terminal 109 receives the invoice from co-ordinator terminal 108.

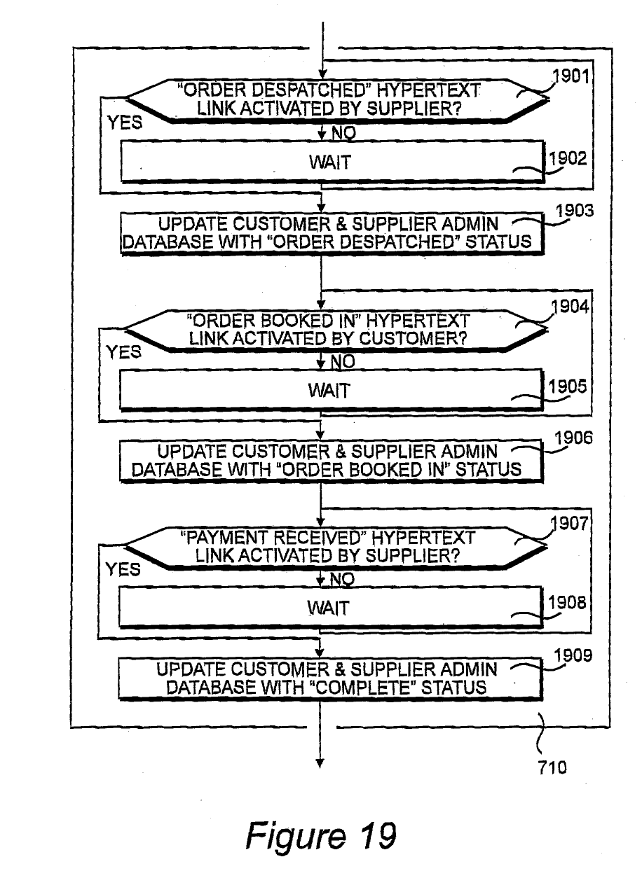

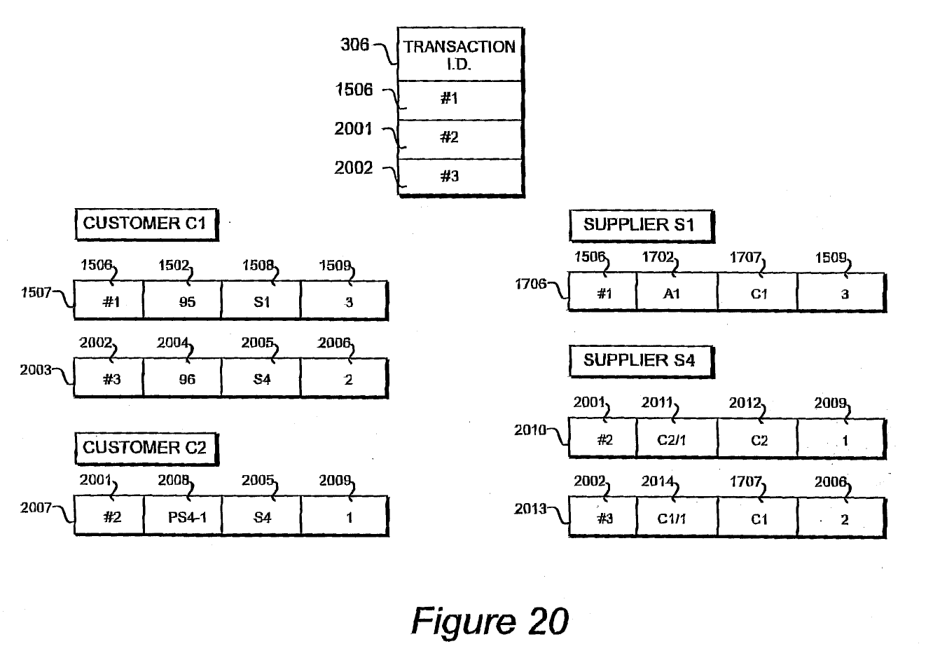

Referring back to FIG. 7, upon supplier S1 accepting the purchase order and a corresponding invoice being generated at step 709, transaction application 303 then enters a database update cycle at step 710. In a preferred embodiment of the present invention, the database update cycle of step 710 is dynamic and persistent. In effect, the referencing of the requisition list stored in the customer administration database 304 and the corresponding payment details stored in the supplier administration database 305 by means of the unique transaction ID 1506 generated by connection database 306 enables both the purchasing officer operating customer terminal 109 and the sales officer operating supplier terminal 101 to respectively update one another about the status of the distributed purchase order. The dynamic characteristic of the database updates performed at step 710 according to the preferred embodiment is illustrated in FIG. 19.

FIG. 19

The purchase order distributed by co-ordinator terminal 108 to supplier terminal 101 is an active server page which contains hypertext links to be activated by the sales officer operating supplier terminal 101 in order to open, ie visualise, the purchase order and notify the despatch of the products or services contained therein. Thus, at step 1901 a question is asked as to whether the “order despatched” hypertext link has been activated by the supplier. If answered in the negative, this translates the fact that the sales officer operating supplier terminal 101 has not physically despatched the order sent by co-ordinator terminal 108 yet and thus at step 1902 the transaction application 303 executes a ‘wait’ instruction and control is subsequently directed again to question 1901 until such time that the question asked at 1901 is answered positively. Upon supplier S1 physically supplying the products or services required by customer C1, then the sales officer operating supplier terminal 101 activates said “order despatched” hypertext link. The transaction application 303 updates the supplier administration database 305 with a “order despatched” status which, by means of the dynamic character of the active server page the purchase order is stored in and, by means of unique transaction ID 1506, also updates the customer administration database 304 with a “order despatched” status at step 1903. According to the dynamic characteristic of the active server page the requisition list is indexed in, the browser of customer terminal 109 is updated with a “order despatched” status. The purchase officer operating customer terminal 109 is thus now aware that his requirement has being processed by supplier S1.

Whereas the active server pages distributed to supplier terminal 101 contain hypertext links, the function of which is to indicate the various stages of the processing of a purchase order received, the active server pages distributed to customer terminal 109 and relating to a requisition list sent to co-ordinator terminal 108 and subsequently forwarded to supplier terminal 101 contain hypertext links, the function of which is to indicate the status of a supply received according to the requisition list sent. Thus, at step 1904, a question is asked as to whether an “order booked in” hypertext link has been activated by the customer, thereby indicating that the purchase officer operating customer terminal 109 has taken effective delivery of the products or services despatched by supplier S1. If the question asked at 1904 is answered in the negative, then transaction application 303 executes a ‘wait’ instruction at step 1905 and control is returned to question asked at 1904 until such time as it is answered positively. Eventually, the products or services stipulated in the requirement list sent at step 1206 are received by customer C1, whereby the purchase officer operating customer terminal 109 activates the “order booked in” hypertext link and, following a process sensibly identical to the updating process explained thereabove, the customer administration database 304 and the supplier administration database 305 are updated with the “order booked in” status at step 1906.

The change in the status of the transaction resulting from the updating step 1906 is reported to the sales officer operating terminal 101 by means of the ASP distributed by co-ordinator terminal 108 to said supplier s terminal 101. The transaction is now ready to be completed and said completion is only dependent upon supplier S1 receiving payment of the invoice sent at step 1805. Thus, at step 1907 a question is asked as to whether the “payment received” hypertext link has been activated by the supplier, thereby indicating that the sales officer operating customer terminal 109 has received effective payment for the products or services despatched to and received by customer C1. If the question asked at 1907 is answered in the negative, then transaction application 303 executes a ‘wait’ instruction at step 1908 and control is returned to question asked at 1907 until such time as it is answered positively. Eventually, customer C1 settles the invoice sent at step 1805, whereby the sales officer operating supplier terminal 101 activates the “payment received” hypertext link and, following a process sensibly identical to the updating process explained thereabove, the customer administration database 304 and the supplier administration database 305 are updated with the “transaction complete” status at step 1909.

Thus, whereas according to the prior art information about the processing of a purchase order is dependent upon a supplier providing timely information entirely at said supplier's convenience, the present invention allows both the purchase officer and sales officer engaged in a transaction to remain accurately informed about the status of a transaction being processed by a system according to the present invention at all times.

The respective supplier administration databases 305 of suppliers S1 and S4 respectively operating terminals 101 and 104, the customer administration databases 304 of customers C1 and C2 respectively operating terminals 109 and 110 and the connections database 306 are shown in FIG. 20, to illustrate the respective contents of said databases in the case of transactions involving multiple customers and multiple suppliers.

FIG. 20

Connections database 306 is stored in co-ordinator terminal 108 and includes transaction ID 1506 which uniquely references a transaction between supplier S1 and customer C1, the details of which were previously explained in the present embodiment. Connections database 306 also store transaction ID 2001, which uniquely references a transaction between supplier S4 and customer C2 and transaction ID 2002, which uniquely references a transaction between said supplier 54 and customer C1.

The second table 1506 in customer administration database 304 of customer C1 is shown as was previously detailed in FIG. 15. A new line entry 2003 in said second table 1507 in customer administration database 304 of customer C1 is shown and references transaction data relating to a second purchase requirement forwarded to supplier S4. Said new line entry 2003 stores the transaction ID 2002, the requisition list identifier 2004, the supplier ID 2005 within supplier administration database 305 to whom the purchase order will be distributed and the buyer ID 2006 inputted in the customer administration database 304 at the time of creating the customer portal 602.

As connection database 306 generates transaction IDs sequentially, the comparison of transaction ID 2002 and transaction ID 2001 indicates that customer C2 forwarded a requirement list prior to the requirement list 2004 of customer C1. The second table 2007 in customer administration database 304 of customer C2 is shown and references transaction data relating to a first purchase requirement forwarded to supplier S4 prior to the purchase requirement of customer C1. Said second table 2007 stores the transaction ID 2001, the requisition list identifier 2008, the supplier ID 2005 within supplier administration database 305 to whom the purchase order will be distributed and the buyer ID 2009 inputted in the customer administration database 304 at the time of creating the customer portal 602.

The second table 1706 in supplier administration database 305 of supplier S1 is shown as was previously detailed in FIG. 17. The second table 2010 in supplier administration database 305 of supplier S2 is shown and stores the transaction ID 2001 instantiated in connections database 306 and uniquely referencing the first purchase requirement received from customer C2, the payment details identifier 2011, the customer ID 2012 within customer administration database 304 to whom the invoice will be distributed and the buyer ID 2009 inputted in the customer administration database 304 by customer C2 at the time of forwarding the requisition list.

According to the example, customer C1 also forwards a requirement list to supplier S4 subsequently to customer C2, and thus a new line entry 2013 in said second table 2010 in supplier administration database 305 of supplier S2 is shown and stores the transaction ID 2002 instantiated in connections database 306 and uniquely referencing the first purchase requirement received from customer C1, the payment details identifier 2013, the customer ID 1707 within customer administration database 304 to whom the invoice will be distributed and the buyer ID 2006 inputted in the customer administration database 304 by customer C2 at the time of forwarding the requisition list.

It can be observed from the example that despite differing data structures used by customers C1 and C2 and suppliers S1 and S4 logged onto co-ordinator terminal 108 in order to reference sales and purchases, said co-ordinator terminal 108 provides a means for customers C1 and C2 to communicate accurately with suppliers S1, S2 and S4, and reciprocally, within a transaction space 106 defined by said co-ordinator terminal 108.

Referring back to FIG. 7, once a transaction has been completed according to step 710, control is then returned to step 701, wherein the co-ordinator terminal 108 updates the portals 602 and the number of supplier sites 601 within the transaction space 106 able to satisfy purchase requirement expressed by customer terminals also present within the said transaction space 106 by means of their respective portals 602. Said co-ordinator terminal 108 thus co-ordinates transactions conducted between customer terminals and supplier terminals and so on and so forth.

What is to be claimed:

1. An apparatus for communicating between supplier and customers, having a plurality of network-connected terminals, including supplier terminals and customer terminals and at least one co-ordinator terminal equipped with memory means, said memory means including instructions to define a transaction space within said network within which
at least one customer portal is created by said co-ordinator terminal in response to information forwarded by at least one of said customer terminals when connecting to said co-ordinator terminal over said network;
at least one supplier information site is created by said co-ordinator terminal in response to information forwarded by at least one of said supplier terminals when logging onto said co-ordinator terminal over said network; wherein
a customer expresses interest for a particular product to the co-ordinator by means of said customer portal;
said co-ordinator terminal performs a search of said supplier information sites to identify at least one preferred supplier information site;
said co-ordinator returns at least one of said supplier information sites to said customer;
said customer conveys a purchase requirement to said co-ordinator terminal based upon a customer-inputted selection within the returned one or plurality of supplier information sites by means of said customer portal;
said co-ordinator terminal sends a formal order to said selected one or plurality of supplier information sites;
said supplier terminal conveys payment details to said co-ordinator terminal; and
said co-ordinator terminal sends a formal invoice to said customer terminal.

2. An apparatus for communicating between supplier and customers according to claim 1, wherein said co-ordinator terminal generates customer portals within said transaction space in response to information forwarded by said customer terminals when logging onto said co-ordinator terminal for the first time.

3. An apparatus for communicating between supplier and customers according to claim 1, wherein said co-ordinator terminal generates supplier information sites within said transaction space in response to information forwarded by said supplier terminals when logging onto said co-ordinator terminal for the first time.

4. An apparatus for communicating between supplier and customers according to claims 1 to 3, wherein said information forwarded by said customer terminals is stored at said co-ordinator terminal in customer-specific pages of a customer administration database and information forwarded by respective supplier terminals is stored at said co-ordinator terminal in supplier-specific pages of a supplier administration database and uploaded supplier-specific pages of a products database.

5. An apparatus for communicating between supplier and customers according to claims 1 to 4, wherein said information stored at said co-ordinator terminal is distributed as active server pages.

6. An apparatus for communicating between supplier and customers according to claims 1 to 5, wherein said transaction space is defined by the total number of customer portals and supplier information sites generated at said co-ordinator terminal.

7. An apparatus for communicating between supplier and customers according to claims 1 and 4, wherein said search performed by said co-ordinator terminal is carried out within the supplier administration database and the products database.

8. An apparatus for communicating between supplier and customers according to claims 1 and 5, wherein said details returned by said co-ordinator terminal include active server pages equipped with hypertext links.

9. An apparatus for communicating between supplier and customers according to claims 1 and 8, wherein said formal order sent by said co-ordinator terminal includes products selected at said customer terminal by means of said hypertext links.

10. An apparatus for communicating between supplier and customers according to claims 1 and 4, wherein said purchase requirement is stored at said co-ordinator terminal in said customer administration database, said payment details are stored at said co-ordinator terminal in said supplier administration database and said purchase requirement and payment details are uniquely referenced by means of a unique transaction ID generated by a connections database stored at said co-ordinator terminal.

11. A method of communicating between supplier and customers, having a plurality of network-connected terminals, including supplier terminals and customer terminals and at least one co-ordinator terminal equipped with memory means, said memory means including instructions to define a transaction space within said network within which
at least one customer portal is created by said co-ordinator terminal in response to information forwarded by at least one of said customer terminals when connecting to said co-ordinator terminal over said network;
at least one supplier information site is created by said co-ordinator terminal in response to information forwarded by at least one of said supplier terminals when logging onto said co-ordinator terminal over said network; wherein
a customer expresses interest for a particular product to the co-ordinator by means of said customer portal;
said co-ordinator terminal performs a search of said supplier information sites to identify at least one preferred supplier information site;
said co-ordinator returns at least one of said supplier information sites to said customer;
said customer conveys a purchase requirement to said co-ordinator terminal based upon a customer-inputted selection within the returned one or plurality of supplier information sites by means of said customer portal;
said co-ordinator terminal sends a formal order to said selected one or plurality of supplier information sites;
said supplier terminal conveys payment details to said co-ordinator terminal; and
said co-ordinator terminal sends a formal invoice to said customer terminal.

12. A method of communicating between supplier and customers according to claim 11, wherein said co-ordinator terminal generates customer portals within said transaction space in response to information forwarded by said customer terminals when logging onto said co-ordinator terminal for the first time.

13. A method of communicating between supplier and customers according to claim 11, wherein said co-ordinator terminal generates supplier information sites within said transaction space in response to information forwarded by said supplier terminals when logging onto said co-ordinator terminal for the first time.

14. A method of communicating between supplier and customers according to claims 11 to 13, wherein said information forwarded by said customer terminals is stored at said co-ordinator terminal in customer-specific pages of a customer administration database and information forwarded by respective supplier terminals is stored at said co-ordinator terminal in supplier-specific pages of a supplier administration database and uploaded supplier-specific pages of a products database.

15. A method of communicating between supplier and customers according to claims 11 to 14, wherein said information stored at said co-ordinator terminal is distributed as active server pages.

16. A method of communicating between supplier and customers according to claims 11 to 15, wherein said transaction space is defined by the total number of customer portals and supplier information sites generated at said co-ordinator terminal.

17. A method of communicating between supplier and customers according to claims 11 and 14, wherein said search performed by said co-ordinator terminal is carried out within the supplier administration database and the products database.

18. A method of communicating between supplier and customers according to claims 11 and 15, wherein said details returned by said co-ordinator terminal include active server pages equipped with hypertext links.

19. A method of communicating between supplier and customers according to claims 11 and 18, wherein said formal order sent by said co-ordinator terminal includes products selected at said customer terminal by means of said hypertext links.

20. A method of communicating between supplier and customers according to claims 11 and 14, wherein said purchase requirement is stored at said co-ordinator terminal in said customer administration database, said payment details are stored at said co-ordinator terminal in said supplier administration database and said purchase requirement and payment details are uniquely referenced by means of a unique transaction ID generated by a connections database stored at said co-ordinator terminal.

21. A computer-readable medium having computer-readable instructions executable by a computer connected to a network such that, when executing said instructions, a computer will perform the steps of
defining a transaction space within said network within which
creating at least one customer portal in response to information forwarded by at least one customer terminal when connected thereto;
creating at least one supplier information site in response to information forwarded by at least one supplier terminal when connected thereto; wherein
receiving interest expressed by a customer for a particular product by means of said customer portal;
performing a search of said supplier information sites to identify at least one preferred supplier information site;
returning at least one of said supplier information sites to said customer;
receiving a purchase requirement from said customer based upon a selection inputted by means of said customer portal within the returned one or plurality of supplier information sites;
sending a formal order to said selected one or plurality of supplier information sites;
receiving payment details from said supplier terminal; and
sending a formal invoice to said customer terminal.

22. A computer-readable memory system having computer-readable data stored therein, comprising
customer administration databases;
supplier administration databases;
connections database
active server pages;
active server pages templates;
program instructions to update said customer administration databases, supplier administration databases, connection database and active server pages; wherein
said customer administration databases, supplier administration databases, connections database and active server pages define a transaction space.

23. A computer-readable memory system according to claim 22, wherein said program instructions are configured to
defining a transaction space within said network within which creating at least one customer portal in response to information forwarded by at least one customer terminal when connected thereto;
creating at least one supplier information site in response to information forwarded by at least one supplier terminal when connected thereto; wherein
receiving interest expressed by a customer for a particular product by means of said customer portal;
performing a search of said supplier information sites to identify at least one preferred supplier information site;
returning at least one of said supplier information sites to said customer;
receiving a purchase requirement from said customer based upon a selection inputted by means of said customer portal within the returned one or plurality of supplier information sites;
sending a formal order to said selected one or plurality of supplier information sites;
receiving payment details from said supplier terminal; and
sending a formal invoice to said customer terminal.
